(19) United States
(12) Patent Application Publication
(10) Pub. No.: US 2005/0104306 A1
(43) Pub. Date: May 19, 2005

(54) Brake steering mechanism for a vehicle

(76) Inventor: Li Mi Jia, Dali City (TW)

Correspondence Address: TROXELL LAW OFFICE PLLC, SUITE 1404, 5205 LEESBURG PIKE, FALLS CHURCH, VA, 22041, US

(21) Appl. No.: 10/706,950

(22) Filed: Nov. 14, 2003

(51) Int. Cl. B62B 13/18

(52) U.S. Cl. 280/11

(57) ABSTRACT

A brake steering mechanism for a vehicle includes a vehicle body having a seat properly disposed at a preset area in opposition to a brake pedal and an acceleration pedal disposed at the front of the vehicle body thereof wherein a left and a right brake sticks are mounted to both lateral sides of the seat and linked to a left and a right brake components of a left and a right front wheels via a first and a second control wires respectively for controlling the movement of the left and right front wheels thereof respectively. A rear wheel with a rear brake component is disposed at the back of the vehicle body wherein the brake pedal is linked to the rear brake component thereof via a third control wire for controlling the movement of the rear wheel thereof. Thus, the vehicle body is easily turned to the left/right via the left/right brake sticks and doubly held in brake via the first, second, and third control wires thereof. Without holding stiffly onto a conventional steering wheel of a vehicle, a driver can drive comfortably with both hands placed naturally onto the left and right brake sticks by both sides of the seat thereof. Besides, with the conventional steering wheel removed there-from, the driver won't be blocked in view by the steering wheel so as to look straight ahead and see clearly the situations on the road to ensure the safety of driving.

### BACKGROUND OF THE INVENTION

The present invention is related to a brake steering mechanism for a vehicle, including a vehicle body having a seat properly disposed at a preset area in opposition to a brake pedal and an acceleration pedal disposed at the front of the vehicle body thereof wherein a left and a right brake sticks are mounted to both lateral sides of the seat and linked to a left and a right brake components of a left and a right front wheels via a first and a second control wires respectively for controlling the movement of the left and right front wheels thereof. A rear wheel with a rear brake component is disposed at the back of the vehicle body and controlled by the brake pedal thereof via the linkage of a third control wire; whereby, the vehicle body is easily turned to the left/right via the left/right brake sticks and doubly held in brake via the first, second, and third control wires thereof. Without holding stiffly onto a conventional steering wheel of a vehicle, a driver can drive comfortably with both hands placed naturally onto the left and right brake sticks by both sides of the seat thereof. Besides, with the conventional steering wheel removed from the front of the car, the driver won't be blocked in view by the steering wheel so as to look clearly into the situations on the road to ensure the safety of driving.

A conventional steering wheel of a vehicle is regularly disposed at the front of the vehicle. A driver must suspend both arms in air and stretch both hands forwards to hold onto the steering wheel, which can easily cause backache or sore shoulder to the driver. Under long driving time, the driver can easily get tired and slow in response to situations on the roads. Thus, it's quite uncomfortable and inconvenient to the driver in respect to the design of the conventional steering wheel thereof. Besides, in case a driver is short in height, the steering wheel thereof can easily block the driver's view. To avoid the problem, the driver must sit straight and strain the neck so as to see clearly the situations on the road, which can also cause stiff neck and tensed nerves to the driver.

### SUMMARY OF THE PRESENT INVENTION

It is, therefore, the primary purpose of the present invention to provide a brake steering mechanism for a vehicle, including a vehicle body having a left and a right brake sticks mounted to both lateral sides of a seat and linked to a left and a right brake components of a left and right front wheels via a first and a second control wires respectively for controlling the movement of the left and right front wheels thereof; whereby, a driver needs only to place both hands naturally onto the left and the right brake sticks by both sides of the seat thereof without holding stiffly onto a conventional steering wheel of a vehicle so as to maintain the most comfortable driving condition.

It is, therefore, the secondary purpose of the present invention to provide a brake steering mechanism for a vehicle wherein the vehicle body thereof is easily turned to the left or the right via the left and the right brake sticks thereof instead of the conventional steering wheel so that, with the conventional steering wheel removed from the front of the vehicle, the driver can look straight ahead and see clearly the situations on the road to ensure the safety of driving.

It is, therefore, the third purpose of the present invention to provide a brake steering mechanism for a vehicle wherein, besides the brake pedal stepped thereon to hold the movement of the rear wheel via the third control wire linked to the rear brake component thereof, the left and the right brake sticks can also be applied synchronically to activate the first and the second control wires thereof respectively to stop the left and the right front wheels at the same time, facilitating a smooth braking as well as a double-layered braking of the vehicle body thereof.

### BRIEF DESCRIPTION OF THE DRAWINGS

FIG. 1 is a perspective view of the present invention in assembly.

FIG. 2 is a sectional view of a transmission mechanism of the present invention.

FIG. 3 is a diagram showing a vehicle body of the present invention turned to the left.

FIG. 4 is a diagram showing the vehicle body of the present invention turned to the right.

FIG. 5 is a top view of the present invention held still in braking operation.

### DETAILED DESCRIPTION OF THE PREFERRED EMBODIMENTS

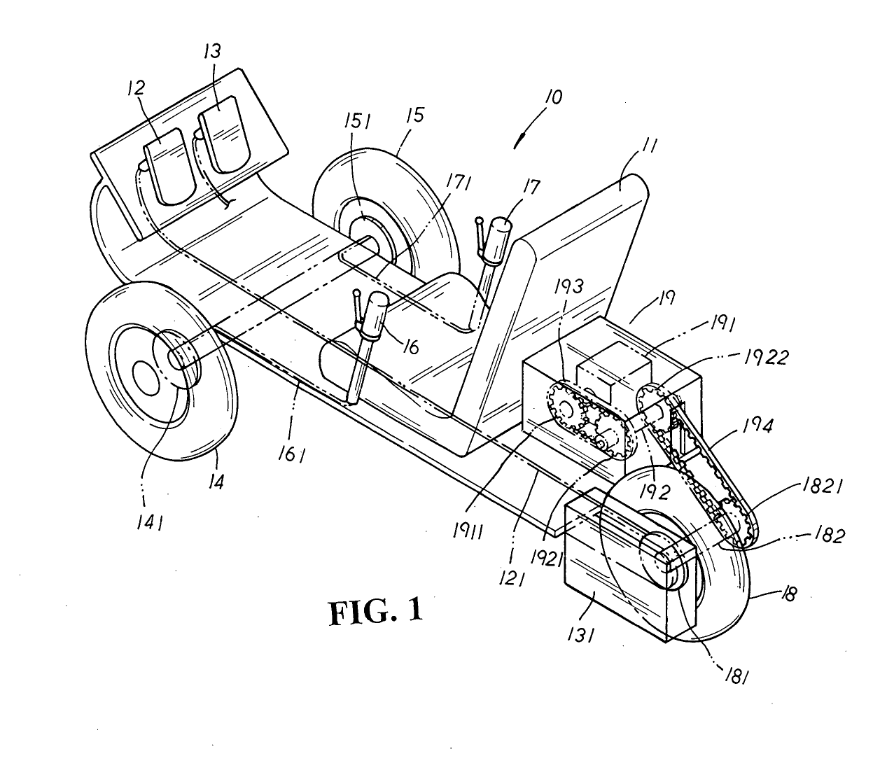

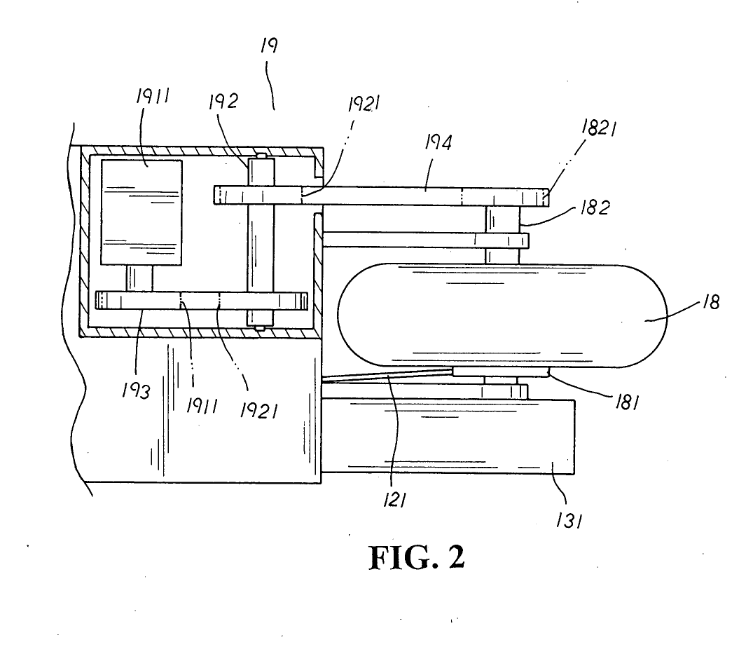

Please refer to FIG. 1. The present invention is related to a brake steering mechanism for a vehicle, including a vehicle body 10 such as a motorcar, an engine-driven car, and a motor-bicycle having a seat 11 properly disposed at a preset area in opposition to a brake pedal 12 and an acceleration pedal 13 disposed at the front of the vehicle body 10 thereof. At both front lateral sides of the vehicle body 10 are disposed a left and a right front wheel 14, 15 with a left and a right brake components 141, 151 such as disk brakes, drum brakes, and regular brakes attached thereto respectively. At both lateral side of the seat 11 are equipped with a left and a right brake sticks 16, 17 linked to the left and the right brake components 141, 151 thereof via a first control wire 161 and a second control wire 171 respectively for controlling the movement of the left and right front wheels 14, 15 thereof respectively. At the back of the vehicle body 10 is provided with a rear wheel 18 having a rear brake component 181 (like a disk brake, a drum brake, and a regular brake) attached thereto, and an axle 182 disposed at the center thereof with a spur transmission gear 1821 mounted at one end of the axle 182 thereof. A third control wire 121 is applied to connect the brake pedal 12 and the rear brake component 181 for controlling the movement of the rear wheel 18 thereof. A gas tank 131 is attached to the rear of the vehicle body 10, and a transmission mechanism 19 is fixed behind the seat 11 thereof as shown in FIG. 2. The transmission mechanism 19 is made up of an engine 191 disposed at one inner side thereof, and a shaft 192 pivotally disposed at the other inner side thereof. A spur-gearing main driving wheel 1911 is mounted to one side of the engine 191, while a left and a right driven wheel 1921, 1922 are attached to both ends of the shaft 192 thereof respectively. A spur-gearing first belt wheel 193 is engaged with the main driving wheel 1911 and the left driven wheel 1921 respectively, and a second belt wheel 194 is joined with the right driven wheel 1922 and the transmission gear 1821 thereof respectively.

In practical use, when the acceleration pedal 13 is stepped thereon to start the engine 191 of the transmission mechanism 19 thereof, the main driving wheel 1911 moved by the engine 191 will activate the first belt wheel 193 to rotate the left driven wheel 1921 and the right driven wheel 1922 therewith which in turn will actuate the second belt wheel 194 to rotate the transmission gear 1821 of the rear wheel 18 and roll forwards the rear wheel 18 in a sequence. Thus, the vehicle body 10 thereof is moved forwards therewith. Meanwhile, the driver's hands can be comfortably placed onto the left and right brake sticks 16, 17 disposed at both sides of the seat 11. Instead of suspending stiffly in air when both hands stretching forwards to hold onto a conventional steering wheel of a car, both arms of the driver can be naturally put downwards at both sides thereof. Thus, via the left and the right brake sticks 16, 17, the driver can maintain the most comfortable driving condition. Besides, with the conventional steering wheel removed from the front of the vehicle, the driver can avoid the problem of being blocked in view by the steering wheel so as to look straight ahead and see clearly the situations on the road to ensure the safety of driving.

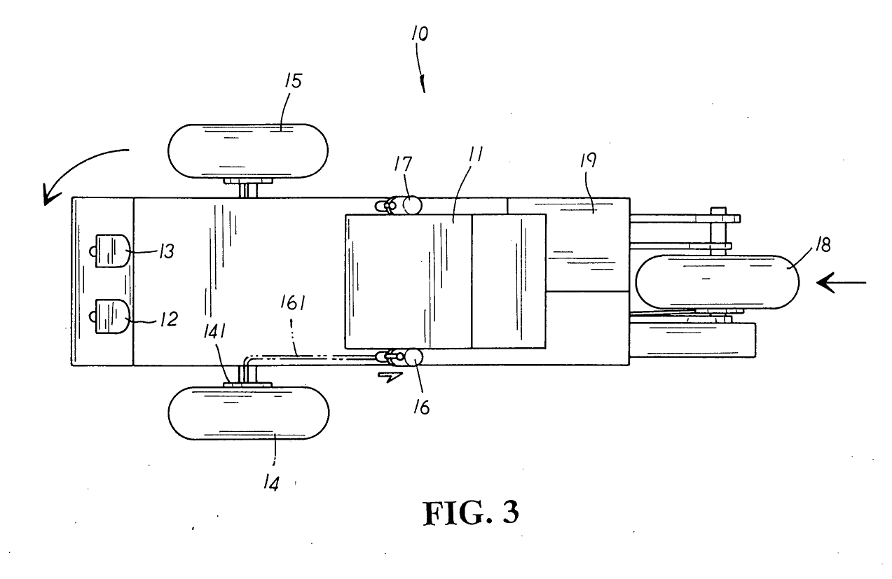

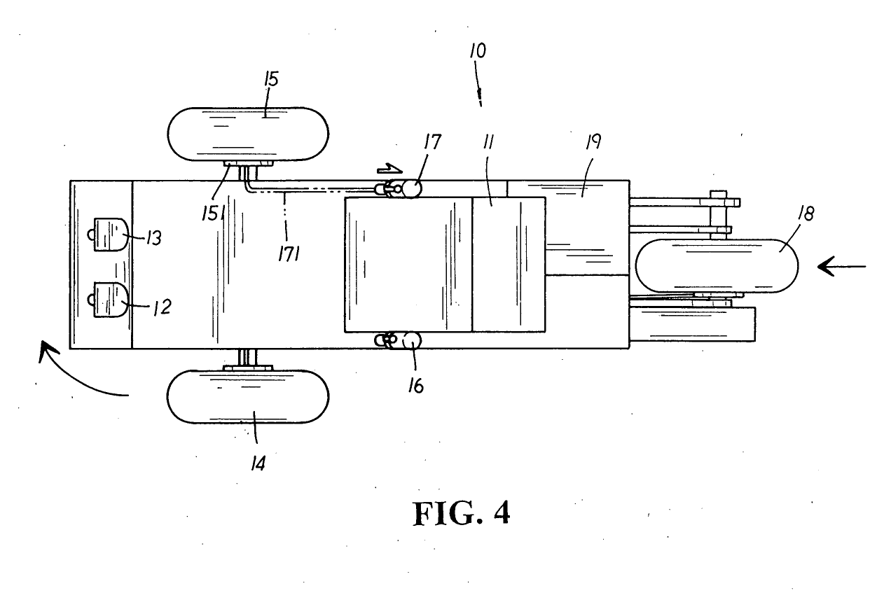

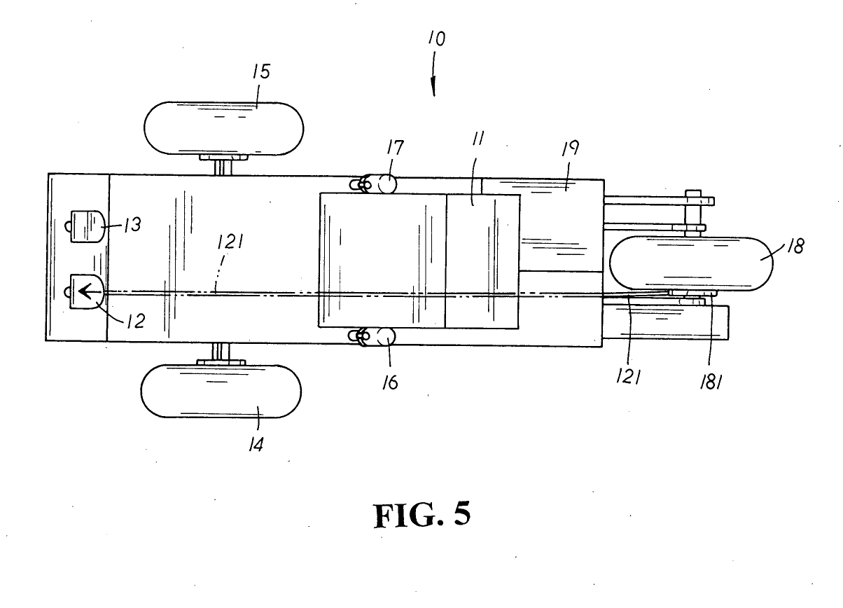

Please refer to FIGS. 3 to 5 inclusive. To turn the vehicle body 10 to the left, the left brake stick 16 is held tight to activate the first control wire 161 and trigger the left brake component 141 so as to stop the left front wheel 14 thereof. With the left front wheel 14 in braking as a pivoting point and the right front wheel 15 kept rolling forwards, the vehicle body 10 is brought to the left in movement as shown in FIG. 3. To turn the vehicle body 10 to the right, the right brake stick 17 is held tight to activate the second control wire 171 and trigger the right brake component 151 so as to stop the right front wheel 15 thereof as a pivoting point and drive the vehicle body 10 to the right via the rolling left front wheel 14 thereof as shown in FIG. 4. To completely stop the movement of the vehicle body 10, the brake pedal 12 is stepped thereon to activate the third control wire 121 and trigger the rear brake component 181 for stopping the rear wheel 18 so as to hold still the vehicle body 10 in braking as shown in FIG. 5. Otherwise, the brake pedal 12 and the left/right brake sticks 16, 17 can be synchronically applied to activate the first, second, and third control wires 161, 171, 121 thereof and trigger the left, right, and rear brake components 141, 151, 181 thereof for stopping the left/right front wheels 14, 15, and the rear wheel 18 thereof at the same time. Thus, the vehicle body 10 is doubly held in brake in a more smooth and easier manner.

1. A brake steering mechanism for a vehicle, including a vehicle body having a seat properly disposed at a preset area in opposition to a brake pedal and an acceleration pedal disposed at the front of the vehicle body thereof; the present invention being characterized by that,
a left and a right front wheels with a left and a right brake components attached thereto respectively being disposed at both front lateral sides of the vehicle body thereof;
a left and a right brake sticks being mounted to both lateral side of the seat thereof and linked to the left and the right brake components thereof via a first control wire and a second control wire disposed thereon respectively for controlling the movement of the left and right front wheels thereof;
a rear wheel being disposed at the back of the vehicle body, having a rear brake component attached thereto and an axle disposed at the center thereof wherein a spur transmission gear is mounted at one end of the axle thereon and a third control wire is applied to link the brake pedal and the rear brake component for controlling the movement of the rear wheel thereof;
a gas tank being attached to the rear of the vehicle body, and a transmission mechanism being fixed behind the seat thereof for activating the rear wheel thereof to move forwards.

2. The brake steering mechanism for a vehicle as claimed in claim 1 wherein the transmission mechanism is made up of an engine disposed at one inner side thereof, and a shaft pivotally disposed at the other inner side thereof; a spur-gearing main driving wheel is mounted to one side of the engine, while a left and a right driven wheel are attached to both ends of the shaft thereof respectively; a spur-gearing first belt wheel is engaged with the main driving wheel and the left driven wheel respectively, and a second belt wheel is joined with the right driven wheel and the transmission gear thereof respectively.
